(19) United States
(12) Patent Application Publication
(10) Pub. No.: US 2013/0026800 A1
(43) Pub. Date: Jan. 31, 2013

(54) HEATING AND COOLING SEATING DEVICE

(71) Applicant: Franklin B. Floyd, JR., Shaker Heights, OH (US)

(72) Inventor: Franklin B. Floyd, JR., Shaker Heights, OH (US)

(21) Appl. No.: 13/310,977

(22) Filed: Dec. 5, 2011

Related U.S. Application Data
(60) Provisional application No. 61/511,703, filed on Jul. 26, 2011.

(51) Int. Cl. A47C 7/74; B23P 11/00

(52) U.S. Cl. 297/180.13; 29/428

(57) ABSTRACT

A seating device with an integral seat, upright back and front wall forming a hollow bench which defines an interior space. A misting manifold with misting nozzles is supported above the upright back and is connected to a water pump which when activated supplies water to the manifold and provides a cooling mist to the entire body of a person sitting on the bench. A heater provides forced heated air to the interior space of the bench and through holes in the front wall of the bench to the deck of a foot platform for directing air upwardly through holes in the deck for total body warmth in cold weather use.

This application claims priority to U.S. Provisional Application No. 61/511,703, filed Jul. 26, 2011, the entirety of which is incorporated by reference herein.

### BACKGROUND

The present disclosure relates to a seating device designed to provide comfort for persons participating in outdoor athletic events such as football games in cool or cold weather and baseball games in warm weather. It has been desired to provide a heat source for observers or participants such as coaches and substitute players in athletic events who are alternately on the side line when not actively engaged on the field. Heretofore, space heaters have been provided for the general area and heated bench seats and radiant heating elements have been employed. However, such devices have generally not proven satisfactory for providing total body warmth in cold weather.

Furthermore, it has been desired to provide a way or means of cooling such participants when off the field in warm weather, particularly after strenuous physical activity on the field. In addition, it has been desired to provide a single device capable of providing total body warmth during cold weather and also capable of alternately providing cooling for the occupant of the seat during warm weather. Heretofore, cooling of the seat occupants during warm weather has been provided by auxiliary devices such as fans for moving air in a general area surrounding the seat.

### SUMMARY

The present disclosure describes a seat for outdoor contests or athletic events which is capable of providing both total body warmth during cold weather and for cooling the occupant of the seat during warm weather in a single self-contained seating unit.

The seat of the present disclosure has an integral seat, upright back and frontal wall below the seat which are enclosed to provide a hollow interior. The frontal wall of the seat has at the foot thereof apertures or perforations which, in one version, communicate with a hollow deck or platform extending forward therefrom for providing a footing. The hollow of the platform communicates with the orifices in the frontal wall of the seat. Perforations in the upper surface of the platform or deck are provided for upward air discharge. A forced air heating unit is connected to the hollow interior of the seat for providing a supply of heated air to the interior of the seat and in one version through frontal wall orifices to provide a direct flow of heated air to the occupants legs and, in another version, to the platform which provides an upward flow of heated air above the platform. The upward flow of heated air from the platform thus provides warmth to the feet and legs of the seat occupant when seated and full body warmth when the occupant is standing on the platform. The seat and back portion are heated by the circulation of warm air to the interior of the seat.

The upright or back portion of the seat has provided thereon a manifold having a plurality of misting orifices or nozzles provided thereon directed to discharge cooling water mist to the entire body of the seated occupant. The manifold is connected to a water pump provided on the back of the seat such, that upon connection of the water pump to a source of water and energization of the pump, a mist is discharged from the manifold misting nozzles to provide vapor cooling of the seated occupant. In one version, the manifold is mounted on a structure extending upwardly from the seat back; and, in another version, the manifold is mounted on the seat back with the misting nozzles provided on tubes extending from the manifold.

The present disclosure thus describes a seating device for outdoor use which provides total body warmth for an occupant whether seated or standing in cold weather and also provides vapor mist cooling to the occupant when seated in warm weather.

### BRIEF DESCRIPTION OF THE DRAWINGS

FIG. 1 is a front perspective view of the seating device of the present disclosure;

FIG. 2 is perspective view from one side and rear of the seating device of FIG. 1;

FIG. 3 is a perspective view of the side opposite FIG. 2 of the seating device of FIG. 1;

FIG. 4 is a section view taken along section indicating lines 4-4 of FIG. 3;

FIG. 5 is a perspective view of a portion of the misting manifold of the device of FIG. 1;

FIG. 6 is a front view of another version of the seating device of the present disclosure;

FIG. 7 is the left side perspective view of the version of FIG. 7;

FIG. 8 is a view similar to FIG. 7 of another version of the seating device of the present disclosure;

FIG. 9 is a front view of another version of the seating device of the present disclosure; and,

FIG. 10 is a perspective view from the back side of the device of FIG. 9.

### DETAILED DESCRIPTION

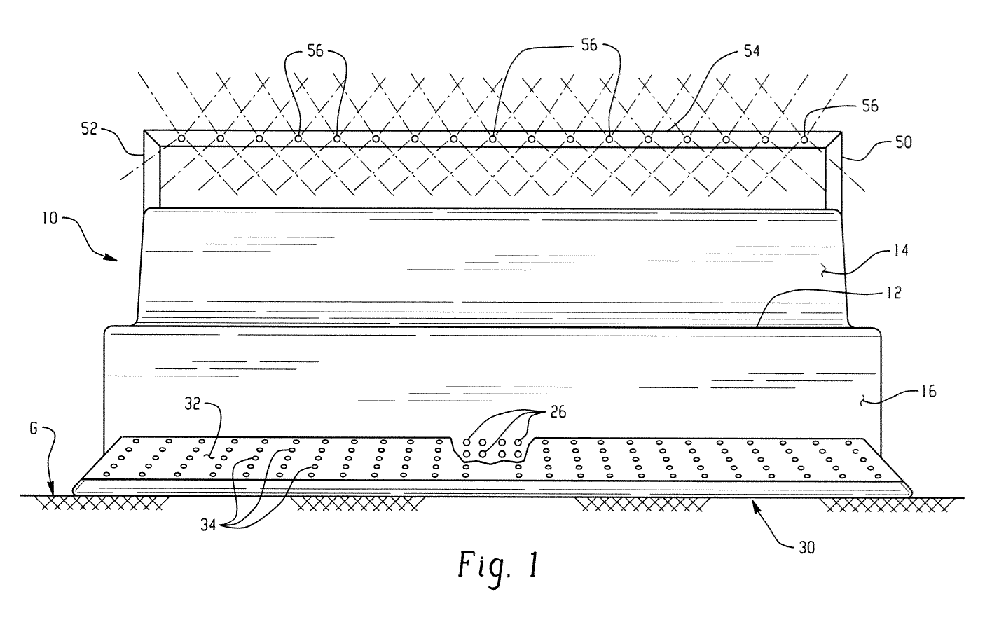

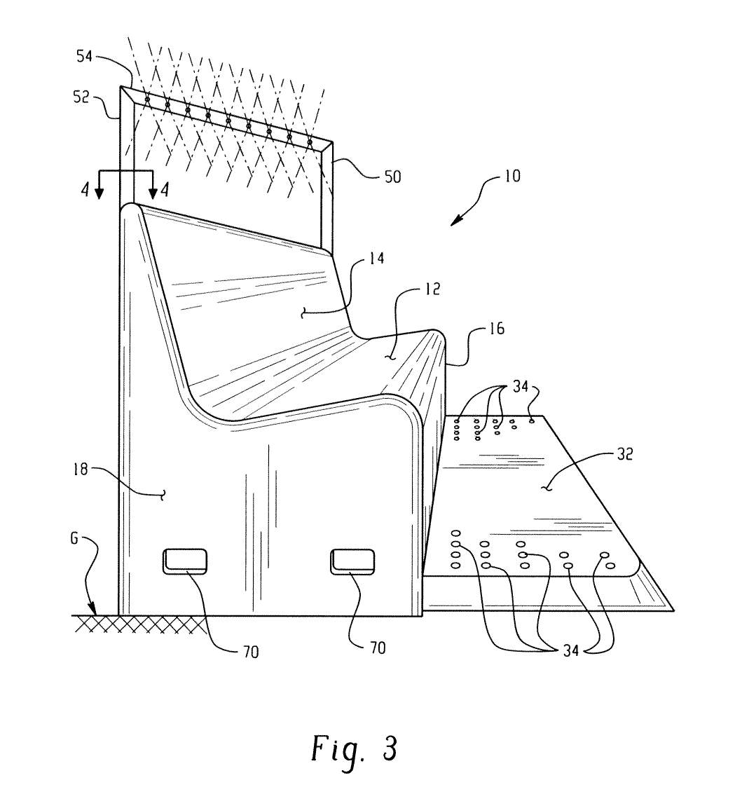

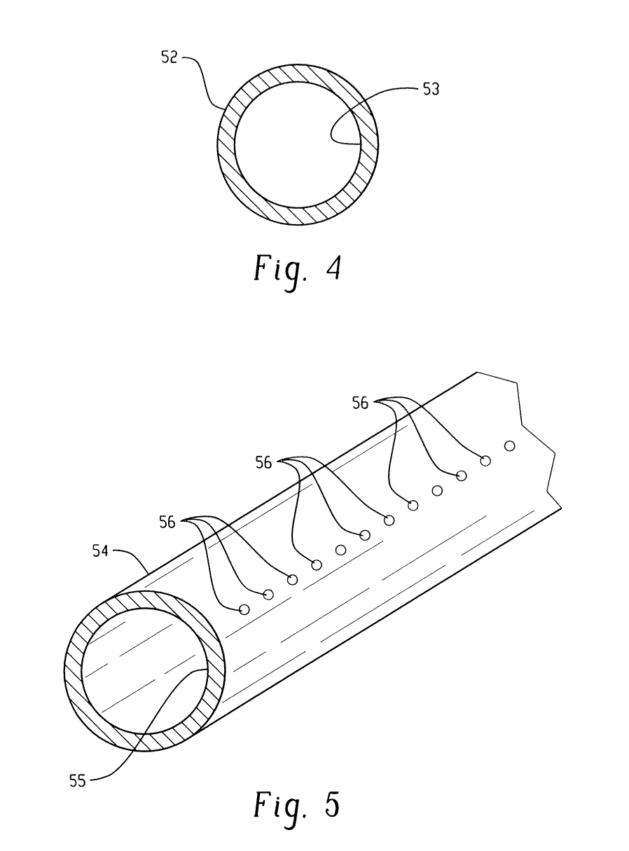

Referring to FIGS. 1-3, one version of a seating device in accordance with the present disclosure is indicated generally at 10 and has a seat portion 12 and upright back portion 14 with a front wall portion 16 below the seat portion 16 which portions are enclosed by a right side wall 18, left side wall 20 and a back 22 and define a hollow interior chamber 24. It will be understood that the chamber 24 is totally enclosed when the device 10 is resting on a flat supporting surface indicated by the reference character “G” or is provided with a base plate closure (not shown). In the present practice, it has been found satisfactory to form the seat 12, upright back portion 14 and front wall portion 16 integrally as one piece; however, alternatively, they may be formed as individual pieces and joined together. In another alternative embodiment, the side walls 18, 22 may be formed integrally as one piece with the seat portion 16, upright back portion 14 and front wall portion 16.

In the version 10, the front wall 16 has, along the lower edge thereof, a plurality of spaced perforations or apertures 26 which communicate with a hollow interior 28 of a forward extending platform or deck 30 for foot rest/foot support 30. The platform 30 has the upper surface 32 thereof provided with a plurality of discharge orifices 34 communicating with the interior 28. The interior or hollow 28 of the platform 30 has an opening in the rear disposed to communicate with the apertures 26 provided in the frontal wall 16 of the seat.

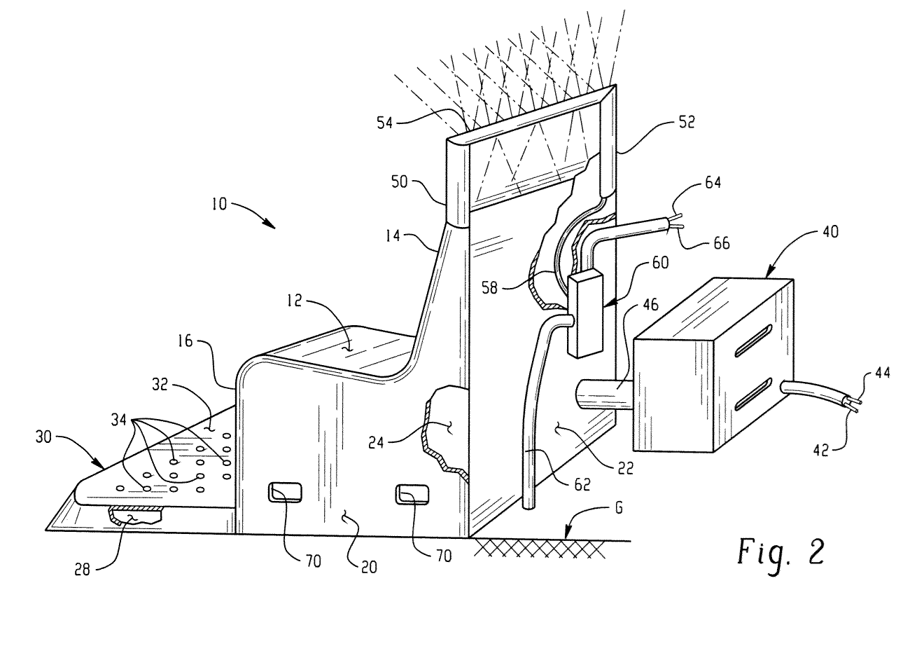

Referring to FIG. 2, a heating unit indicated generally at 40 includes a heating element (not shown) and a blower (not shown) which are adapted for connection to an external source of electrical power through leads 42, 44. The heating unit is connected through a heated air conduit 46 connected through the back 22 of the seating unit 10 to the interior hollow 24 of the seat 10. Alternatively, the heating unit may be attached to the back 22 of the bench. Upon energization of the heating unit 40, warm air is forced through conduit 46 to the interior 24 of the seating device 10 and effects warming of the seat 12 and back 14 and also provides a flow of warm air through the apertures 26 to the interior 28 of the platform 30 and discharges warm air vertically upward through the orifices 34 provided in the platform 30. Thus, the occupant of the seat, when seated, is warmed by conduction through the seat 12 and back 14 and by convection of forced air through the orifices 34 in the platform thereby, providing total body warmth. When the occupant is standing on the platform 30, the occupant is continually warmed by the vertically upward flow of warmed air forced through the apertures 34 in the platform 30.

The upright portion of the seating device 10 comprising the seat back 14, the back 22 and upright portions of the sides 18, 20 has provided on the top thereof, spaced uprights or posts 50, 52 at least one of which uprights is hollow; and, the uprights 50, 52 support a horizontally disposed tubular manifold 54.

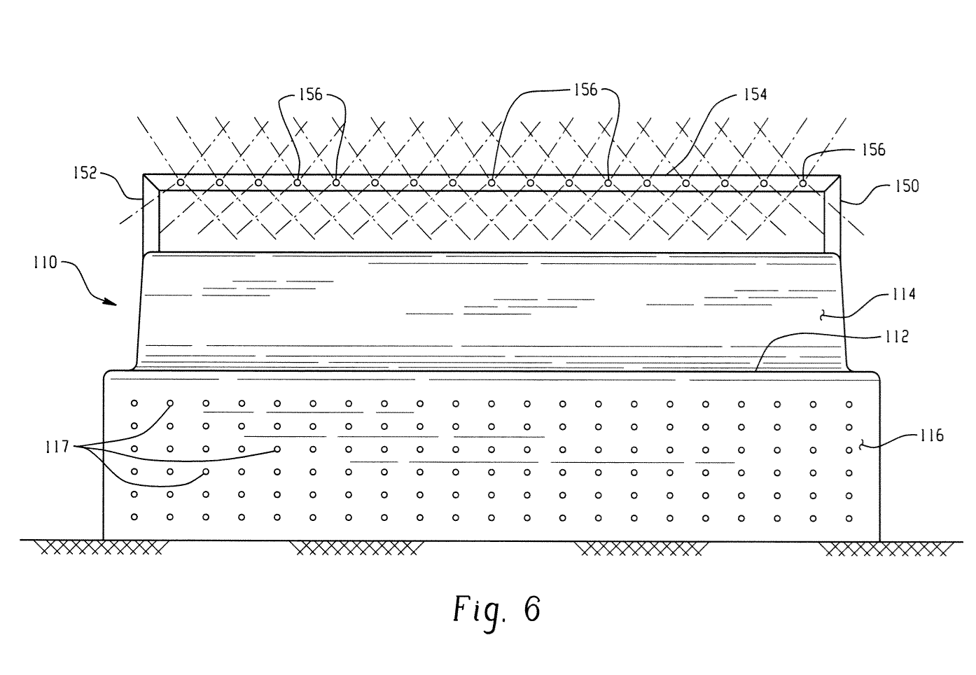

Referring to FIG. 5, a portion of the manifold is shown with a plurality of horizontally spaced orifices or mist nozzles 56 which are sized to provide a fine mist when water in the manifold is forced therethrough. Alternatively, as will be hereinafter described with respect to another version, the manifold may be mounted on the seat upright back and the nozzles 56 disposed on individual tubes from the manifold extended upward above the upright back portion.

The manifold is supplied a flow of water through the hollow upright 52 which is connected through a conduit, which may comprise a flexible hose 58, to a water pump, indicated generally at 60, which may be attached to the back 22 of the seating device 10. Pump 60 is adapted for connection to an external source of water, such as through a hose 62 and to a source of electrical power through leads 64, 66. Upon energization of the pump 60, water supplied through hose 62 is fed through upright 52 to the interior 55 of the manifold 54 and is dispersed through the orifices 56 as a fine mist for effecting cooling of the entire body of the seated occupant.

If desired, a plurality of handles 70 may be provided for facilitating installation or portability.

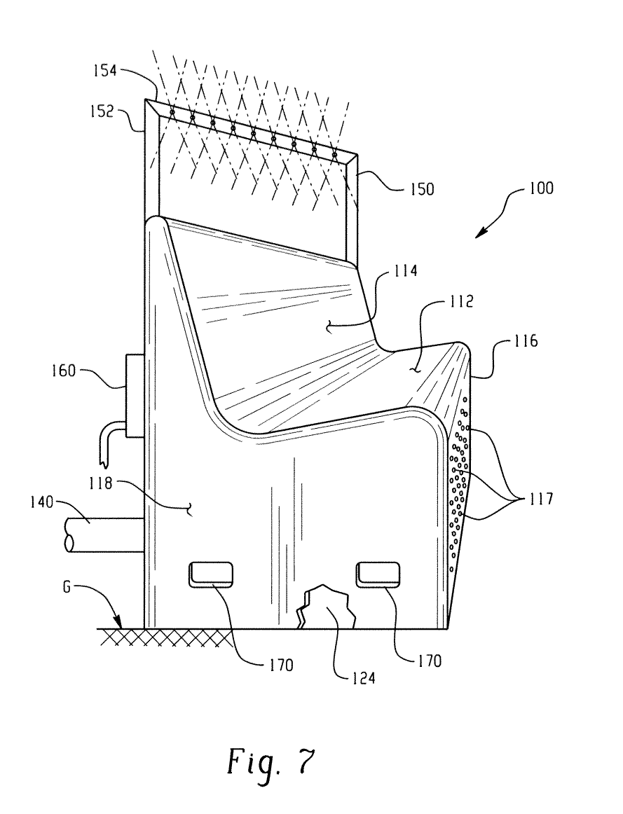

Referring to FIGS. 6 and 7, another version of the seating device of the present disclosure is indicated generally at 100 and includes a bench having a seat 112 integrally formed upright back portion 114 and a frontal wall portion 116 which, together with end walls such as 118, define a hollow interior space. The wall portion 116 has a plurality of apertures or orifices 117 formed therein which communicate with the hollow interior.

Although not shown in FIG. 6 and FIG. 7, a source of heated air such as that shown at 40 in FIG. 2 is connected to the seat back through a heating duct 140 to communicate heated air with the hollow interior 124 for heating the seat 112, seat back 114 and front wall 116 and discharging heated air through the orifices 117.

The version 100 includes spaced upright tubes 150, 152 connected to a horizontal manifold 154 which has a plurality of misting nozzles 156 spaced there along. The manifold is connected to a source of water such as pump 160 for providing pressurized water through the uprights to the manifold 154 and the misting nozzles 156. The version 100 thus provides warmth to the seat occupant by directly warming the seat back and seat by conduction from the heated air in the hollow interior 124 and warms the legs of the seated occupant by discharge of heated air through the orifices 117 in the front wall 116. Cooling of the seated occupant is provided by discharge of the mist through the nozzles 156.

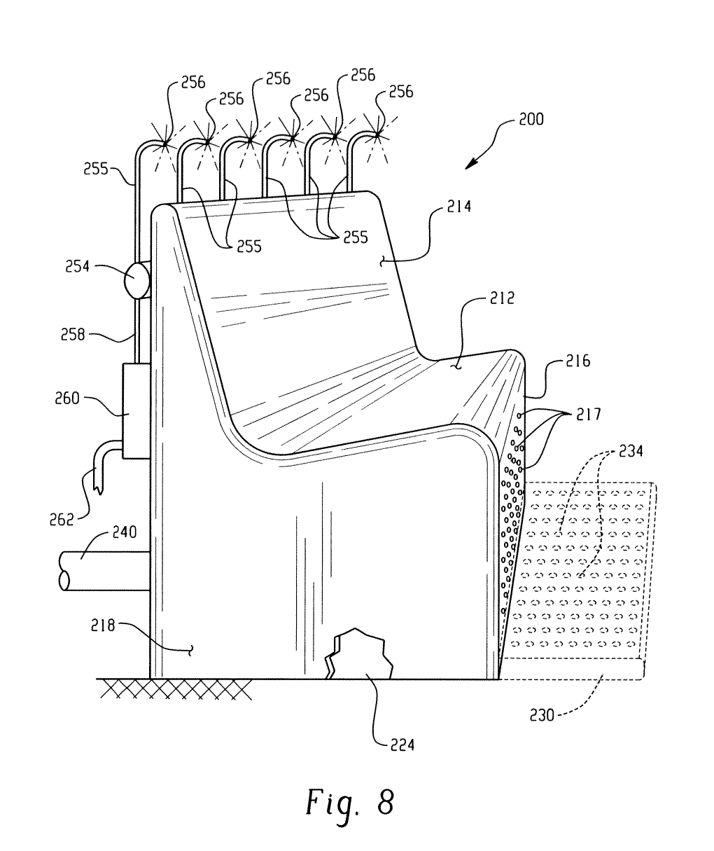

Referring to FIG. 8, another version of the heating and cooled seating device of the present disclosure is indicated generally at 200 includes integral formed seat 212, back 214 and front wall 216 with end plates such as 218 which form a hollow interior 224. The rear face of the seat back 214 has connected thereto a source of heated air through a duct 240 which communicates with the hollow interior 224 and supplies air through orifices 217 provided in the front wall portion. The heated air entering the hollow interior 224 thus heats the seat back, seat and front wall portion by conduction; and, heated air is discharged to the orifices 217 for warming the legs of the seated occupant. Optionally, a deck or platform 230 shown in dashed outline may extend from the front wall portion 216 and may be hollow to communicate with the interior region 224 of the seat through orifices 217 provided in the lower portion of frontal wall 216 and having upwardly facing discharge orifices 234 for providing an upward flow of heated air if desired. It will be understood that if the platform 230 is employed, orifices 217 will be omitted above the platform.

The rear face of the seat back 214 has mounted thereon a manifold 254 which communicates via a conduit 258 with a pump 260 supplied with water through a supply conduit 262. The manifold has a plurality of spaced upwardly extending tubes 255, attached thereto, each of which has a misting nozzle 256 provided therein for discharging cooling mist to cool the seated occupant. If desired, the tubes 255 may be formed of semi-rigid or somewhat flexible material to permit the seated occupant to vary the orientation of the nozzles.

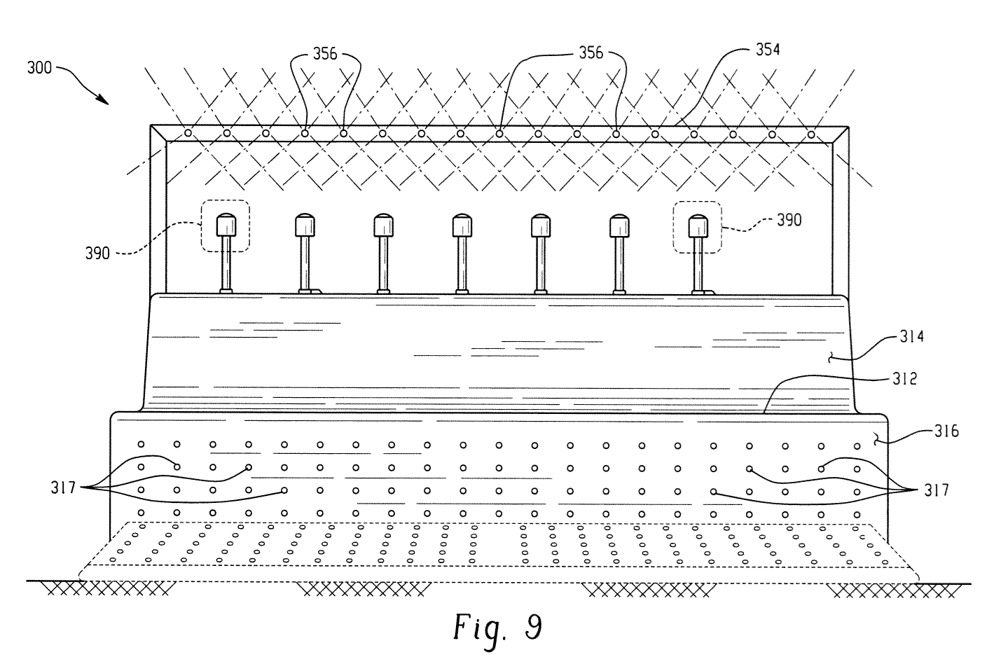

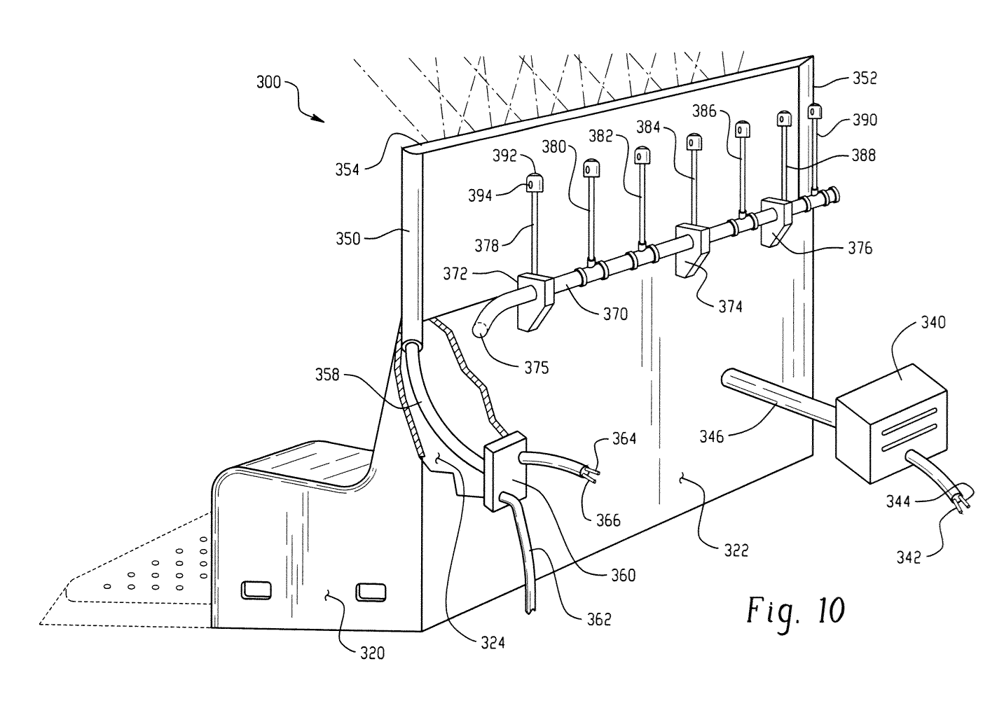

Referring to FIGS. 9 and 10, another version of the heating and cooling seating device of the present disclosure is indicated generally at 300 and includes a unitary bench having a seat 312, an upright back 314 and front panel 316 with end plates, such as plate 320, which form an interior cavity 324. The front panel 316 has a plurality of apertures or orifices 317 therein similar to the orifices 217 of the version of FIG. 8. A source of heated air 340 includes a heating element and blower (not shown) powered through electrical leads 342, 344. The leads are connected to a source of electrical power to provide heated air from source 340, through a conduit 346 connected from the source 340 to the interior cavity 324 of the bench to the back panel 322.

A pair of spaced uprights 350, 352 extend upwardly from the ends of the back 314 of the bench and support a manifold 354 which is arranged to extend generally horizontally therebetween. The manifold has a plurality of misting nozzles 356 disposed there along for discharging misting vapor onto the occupants of the bench seat 312.

Referring to FIG. 10, at least one of the uprights, such as upright 350, comprises a hollow tube and has water supply conduit with hose 358 connected thereto and which is connected to the discharge or outlet of a water pump 360 which is powered through electrical leads 364, 366 and supplied from a source of water through supply line 362. In the manner similar to the version of FIG. 2, the version 300 discharges vapor mist through the misting nozzles 356 upon energization of pump 360 when it is connected to a source of water nearby providing a cooling mist for the occupants of the bench.

A hot air duct 370 is disposed along the top edge of the rear panel 322 of upright seat back in a generally horizontal arrangement and is supported by brackets 372, 374. The duct 370 is closed at the distal end in FIG. 10; and, the proximal end 375 is connected through back panel 322 to the interior cavity 324 of the bench for receiving heated air therefrom.

Disposed along the duct 370 is a plurality of upwardly extending tubes 378, 380, 382, 384, 386, 388, and 390, each of which has a cap denoted typically at 392 thereon and each cap has an aperture or discharge port such as port 394 for permitting discharge of heated air supplied from the duct 370. Each of the caps 392 is configured for supporting headgear such as a helmet indicated at 390 and shown in dashed outline thereon; and, the heated air from the discharge orifice 394 thus maintains a helmet placed thereover in a warm and dry state. The seating device 300 of FIGS. 9 and 10 thus maintains the seat occupant warm by conduction of the heated seat and upright back and by convection through the front panel orifices 317 in cool weather. Additionally, the seat occupants may place any protective head gear or helmets over the caps 392 for maintaining their head gear warm and dry. In warm weather, the seat occupant is cooled by vapor mist discharging from orifices 356 in the overhead manifold 354.

As shown in dashed outline in FIGS. 9 and 10, if desired, a foot platform or deck may be provided in the same manner as the version 10 of FIGS. 1 and 2. It will be understood that if such a foot platform is provided, the front panel orifices 317 above the platform will be eliminated in favor of the heated air discharge orifices in the upper surface of the foot platform.

The seating device of the present disclosure thus provides a seat or bench having a chamber below the seat and behind the back into which warm air is forced to provide body warmth to the seated occupant. The closed front of the seating device has a plurality of apertures for providing, in one version, heated air directly to the occupants legs; and, in another version, to a hollow foot platform extending forward from the lower region of the front wall of the platform seat. The platform has apertures on the top surface thereof for directing a vertically upward flow of warmed air for providing warmth to the feet and legs of the occupant when seated and full body warmth when the occupant is standing on the platform. The back of the seating device has, in one version, uprights provided thereon for supporting a vapor misting manifold extending horizontally above the back of the and a water pump is connected for providing a flow of water to the misting orifices in the manifold to provide vapor mist cooling of the entire body of the seated occupant. In another version, the manifold is mounted on the seat back and has a plurality of tubes extending upwardly therefrom, each with a misting nozzle.

The disclosed versions have been described with reference to the drawings. Obviously, modifications and alterations will occur to others upon reading and understanding the preceding detailed description. It is intended that the illustrated version be construed as including all such modifications and alterations insofar as they come within the scope of the appended claims.

1. A seating device comprising:
(a) a bench having a seat, back and frontal wall and defining an enclosed interior space, the frontal wall having a plurality of apertures therethrough;
(b) a foot platform having a hollow interior extending from the frontal wall and having a plurality of apertures on an upper surface thereof communicating with the hollow interior, wherein the hollow interior communicates with the frontal wall apertures;
(c) a manifold disposed above the seat back and having a plurality of spaced misting orifices; and,
(d) a source of heated air operably connected to supply heated air to the enclosed interior space for heating the seat, back and frontal wall and to effect discharge of heated air upwardly through the apertures in the upper surface of the foot platform; and,
(e) a pump connected to the manifold and operable upon connection to a source of water to effect discharge of mist through the manifold orifices for cooling of the entire body of the seat occupant.

2. The device defined in claim 1, wherein the seat, upright back and frontal wall are integrally formed.

3. The device defined in claim 1, wherein the enclosed interior space includes left and right side walls formed integrally as one piece with the seat, back and frontal wall.

4. The device defined in claim 1, wherein manifold orifices include nozzles.

5. The device defined in claim 1, wherein the manifold is supported by a pair of spaced unrights.

6. The device defined in claim 5, wherein one of the uprights is hollow and connected to the pump for supplying water to the manifold.

7. The device defined in claim 5, wherein the manifold includes a horizontally disposed tubular member.

8. The device defined in claim 1, wherein the pump is attached to the back of the bench.

9. The device defined in claim 1, wherein the pump is connected to the manifold with a flexible hose.

10. A method of making a heating and cooling seating device comprising:
a) forming a hollow bench with a seat, upright back and front wall portion and forming a closed interior space;
b) providing a hollow foot platform with apertures in the upper surface thereof and connecting the hollow to the closed interior space through the front wall portion;
c) providing a source of heated air and connecting the source to the closed interior space and the foot platform apertures;
d) providing a misting manifold and supporting the manifold above the upright back portion; and,
e) attaching a pump to the upright portion back of the bench and connecting the pump to the misting manifold for supplying water thereto.

11. The method defined in claim 10, wherein forming a hollow bench includes forming the seat, upright back and front wall portion integrally as one piece.

12. The method defined in claim 10, wherein forming a hollow bench further comprises forming left and right side walls integrally as one piece with the seat, upright back and frontal wall portions.

13. The method defined in claim 10, wherein supporting the misting manifold includes providing a pair of spaced uprights on the seat back portion.

14. The method defined in claim 13, wherein the providing a pair of spaced uprights includes providing a hollow upright; communicating with the manifold; and, connecting a pump to the manifold includes connecting the pump to the hollow upright.

15. The method defined in claim 14, wherein connecting the pump to the hollow upright includes connecting with a flexible hose.

16. A method of making a heating and cooling seating device comprising:
(a) forming a hollow bench with a seat, upright back and front wall portion and forming a closed interval space;
(b) providing a hollow foot platform with apertures in the upper surface thereof in communication with the hollow and connecting the hollow to the closed interior space through the front wall portion;
(c) providing a source of heated air and connecting the source to the closed interior space and foot platform hollow;
(d) providing a manifold and connecting to a plurality of misting nozzles disposed above the upright back;
(e) connecting a pump to the manifold and a source of water for supplying water to the nozzles.

17. The method defined in claim 16, wherein the connecting to a plurality of misting nozzles include disposing the manifold above the upright back portion.

18. A seating device comprising:
(a) a bench having a seat, seat back and frontal wall and defining an enclosed interior space, the frontal wall bearing a plurality of apertures therethrough;
(b) a source of heated air operably connected to supply heated air to the enclosed interior space for heating the seat, seat back and frontal wall to effect discharge of heated air through the apertures;
(c) a manifold connected to supply a plurality of misting nozzles disposed above the seat back; and,
(d) a pump connected to the manifold and operable upon connection to a source of water to affect discharge of mist through the nozzles for cooling the entire body of the seat occupant.

19. The device defined in claim 18 wherein the manifold is disposed above the seat back.

20. The device defined in claim 19, wherein the nozzles are disposed on the manifold.

21. The device defined in claim 18, further comprising a front platform having a hollow interior and extending from the frontal wall and having a plurality of apertures on an upper surface thereof communicating with the hollow interior wherein the hollow interior communicates with the frontal wall apertures.

22. The device of claim 18, wherein the manifold has a plurality of tubes extending therefrom, each tube having a misting nozzle thereon.
